(19) United States
(12) Patent Application Publication
(10) Pub. No.: US 2011/0264256 A1
(43) Pub. Date: Oct. 27, 2011

(54) PROCESS CONTROL METHOD AND PROCESS CONTROL SYSTEM

(75) Inventors: Yu-Chin Cheng, Kaohsiung County (TW); Wen-Kuang Tai, Tainan City (TW)

(73) Assignee: UNITED MICROELECTRONICS CORP., Hsinchu (TW)

(21) Appl. No.: 12/765,161

(22) Filed: Apr. 22, 2010

(51) Int. Cl. G06F 19/00

(52) U.S. Cl. 700/105

(57) ABSTRACT

A process control method is provided for controlling a tool which processes a deposition process on a plurality of wafers for a process time. The process control method comprises receiving a quantity of the wafers and calculating a deposition compensation time necessary for the deposition process performed on the wafers by the tool according to the quantity of the wafers and a deposition loading effect coefficient corresponding to the deposition process. The deposition loading effect coefficient is retrieved from a database according to a process program of the deposition process. According to the deposition compensation time, the process time is adjusted to be an adjusted process time. The deposition process is performed on the wafers for the adjusted process time by the tool.

### BACKGROUND OF THE INVENTION

1. Field of the Invention

The present invention relates to a semiconductor process control method and a system using the same, and more particularly, to a deposition process control method and a system using the same.

2. Description of Related Art

As the line width of IC device becomes smaller, the control of its properties gets more important. A characteristic value of an IC device usually relates to a plurality of processes in its manufacturing procedure, while the processes include a plurality of variables correlated with the characteristic value that have a number at least equal to the number of the processes. The variables are the keys for controlling the characteristic value of the IC device.

One process control method as a self-correction method is provided in the prior art. The standard values of respective variables in combination corresponding to the target value of the result parameter are determined first. The respective processes correlated with the result parameter are controlled such that the difference between the real value of each variable and the standard value of the same is minimized. Thus, the value of the result parameter is close to the target value of the same.

In an advanced process control (APC) method in the prior art, after the value of a variable of a process is found to have a substantial deviation, a variable of a subsequent process run is adjusted according to the operator's experience to directly compensate the deviation of the variable of the former process run. For example, in an IC manufacturing procedure including a deposition process and a later CMP process, the CMP-removed thickness is increased if the deposition thickness is overly large, or is decreased if the deposition thickness is overly small.

The aforementioned conventional APC method is a closed-loop feedback method for directly compensating the deviation of the variables to be the process variables in the later performed process. Hence, the conventional APC needs to take the risk that the process result of the batch of wafers of the current process run seriously drift away from the standards. Also, it is very time consuming for waiting the measurement result of the batch of wafer of the current process run so as to compensate the deviation of the process parameters for the next process run. Thus, it is hard to decrease the process cycle time and increase the process throughput.

### SUMMARY OF THE INVENTION

The present invention provides a process control method capable of increasing the process accuracy.

The present invention provides a process control system capable of decreasing the process cycle time and increasing the process throughput.

The invention provides a process control method for controlling a tool to process a deposition process on a plurality of wafers for a process time. The process control method comprises receiving a quantity of the wafers. A deposition compensation time necessary for the deposition process performed on the wafers by the tool is calculated according to the quantity of the wafers and a deposition loading effect coefficient corresponding to the deposition process, wherein the deposition loading effect coefficient is retrieved from a database according to a process program of the deposition process. The process time is adjusted to be an adjusted process time according to the deposition compensation time. The deposition process is performed on the wafers for the adjusted process time by the tool.

According one embodiment of the present invention, the tool includes a furnace.

According one embodiment of the present invention, the step of calculating the deposition compensation time according to an equation: DT=WN×LEC, wherein DT denotes the deposition compensation time, WN denotes the quantity of the wafers and LEC denotes the deposition loading effect coefficient.

According one embodiment of the present invention, the deposition loading effect coefficient is obtained by calculating a thickness-wafer quantity relationship according to a plurality of history deposition thickness values obtained by performing the deposition process with respect to the same process program on the wafers in the tool, and the quantities of the wafers respectively corresponding to the history deposition thickness values.

According one embodiment of the present invention, the thickness-wafer quantity relationship and a deposition rate of the deposition process are used to calculate a unit-wafer compensation time for the deposition process performed according to the process program as the deposition loading effect coefficient.

The invention further provides a process control system for controlling a tool to process a deposition process on a plurality of wafers for a process time. The process control system comprises a database, a receiving unit, a calculation unit, a deposition time adjusting unit and a control unit. A deposition loading effect coefficient is retrieved from the database according to a process program of the deposition process. The receiving unit is used for receiving a quantity of the wafers. The calculation unit is used for calculating a deposition compensation time necessary for the deposition process performed on the wafers by the tool according to the quantity of the wafers and a deposition loading effect coefficient corresponding to the deposition process. The deposition time adjusting unit is used for adjusting the process time to be an adjusted process time according to the deposition compensation time. The control unit is used for controlling the tool to perform the deposition process on the wafers for the adjusted process time.

According one embodiment of the present invention, the tool includes a furnace.

According one embodiment of the present invention, the calculation unit calculates the deposition compensation time according to an equation: DT=WN×LEC, wherein DT denotes the deposition compensation time, WN denotes the quantity of the wafers and LEC denotes the deposition loading effect coefficient.

According one embodiment of the present invention, in the database, the deposition loading effect coefficient is obtained by calculating a thickness-wafer quantity relationship according to a plurality of history deposition thickness values obtained by performing the deposition process with respect to the same process program on the wafers in the tool, and the quantities of the wafers respectively corresponding to the history deposition thickness values.

According one embodiment of the present invention, the thickness-wafer quantity relationship and a deposition rate of the deposition process are used to calculate a unit-wafer compensation time for the deposition process performed according to the process program as the deposition loading effect coefficient.

Accordingly, in the present invention, before each run of the deposition process, the process control system calculates a deposition compensation time for the current process run according the quantity of wafers in the current process run. Hence, the deposition process which is performed for the adjusted process time according to the deposition compensation time can overcome the problem that the deposition thickness varies with the quantities of the wafers in different process runs due to the deposition loading effect. Moreover, before the deposition process is performed, the deposition compensation time for the current process run is calculated according to the corresponding deposition loading effect coefficient provided by the database. Thus, it is unnecessary to waste time for waiting for the measurement result of the deposition process of the current process run to feedback the process parameters of the next process run. Hence, the process control method and the process control system of the present invention can effectively increase the accuracy of the process, decrease the process cycle time and increase the process throughput.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a process control system according to one embodiment of the invention.

FIG. 2 is a flow chart illustrating a process control method according to one embodiment of the invention.

FIG. 3 is a plot diagram showing a deposition thickness-wafer quantity relationship according to one embodiment of the present invention.

### DESCRIPTION OF EMBODIMENTS

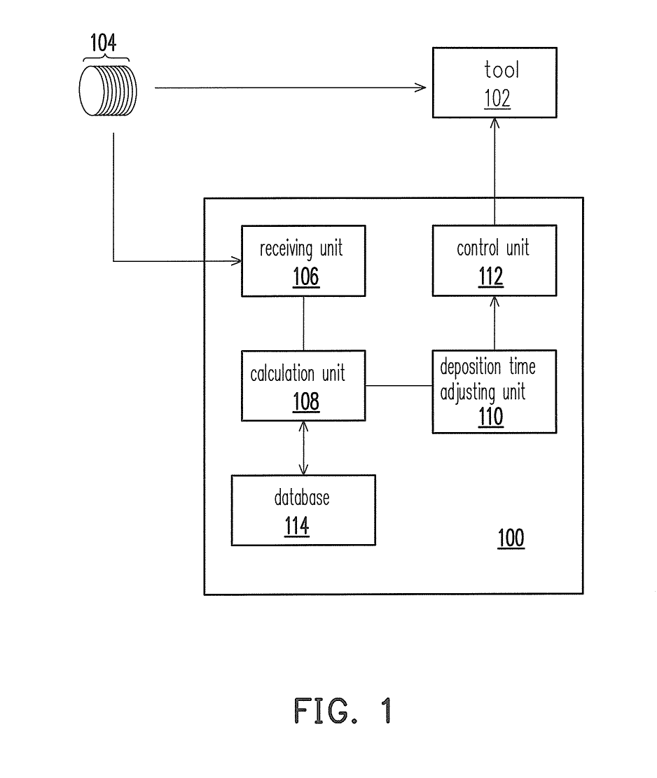

FIG. 1 is a flow chart illustrating a process control system according to one embodiment of the invention. As shown in FIG. 1, a process control system 100 of the present invention is used for controlling a tool 102 to process a deposition process on a plurality of wafers 104 for a process time. The process control system 100 comprises a receiving unit 106, a calculation unit 108, a deposition time adjusting unit 110 and a control unit 112. Moreover, in one embodiment, the process control system 100 further comprises a database 114. The tool 102, for example, performs the deposition process according to the particular process program. The aforementioned process program, for example, includes various process parameters. Moreover, the aforementioned tool can be, for example, a furnace. Also, the aforementioned deposition process can be, for example, a thermal oxidation process.

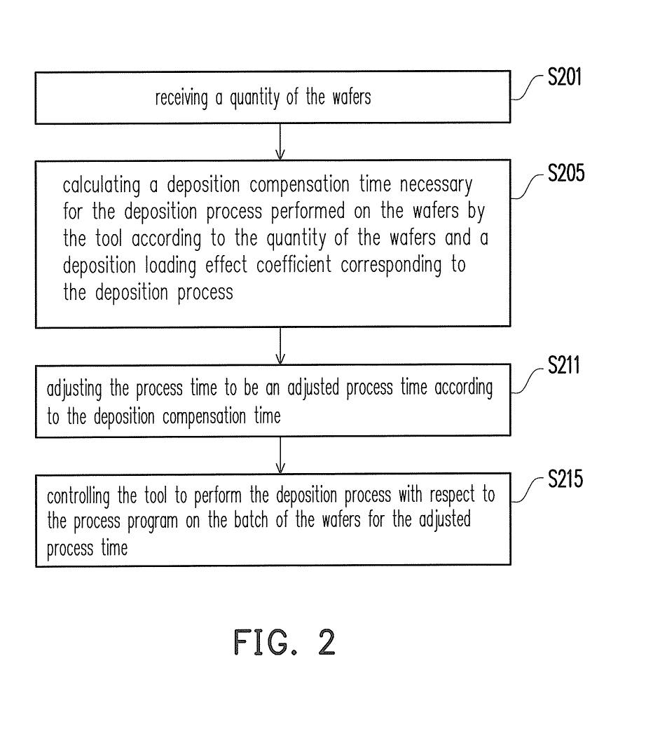

FIG. 2 is a flow chart illustrating a process control method according to one embodiment of the invention. As shown in FIG. 1 and FIG. 2, before the tool 102 performs the deposition process on a batch of wafers (such as the batch of wafers 104 shown in FIG. 1), the receiving unit 106 of the process control system 100 receives a quantity of the wafers 104 (step S201). That is, before the batch of wafers 104 enters the tool 102 or between the steps of transferring the wafers 104 into the tool 102 and performing the deposition process on the wafers 104, the quantity of the wafers 104 which are to be transferred into the tool 102 or have already loaded into the tool 102 is manually inputted by the user or automatically inputted into the process control system 100.

Thereafter, in the step S205, the calculation unit 108 of the process control system 100 is used for calculating a deposition compensation time necessary for the deposition process performed on the wafers by the tool 102 according to the quantity of the wafers 104 and a deposition loading effect coefficient corresponding to the deposition process. In the present embodiment, the calculation unit 108 calculates the deposition compensation time, for example, according to an equation: DT=WN×LEC, wherein DT denotes the deposition compensation time, WN denotes the quantity of wafers 104 and LEC denotes the deposition loading effect coefficient. In other words, different deposition processes (i.e. the deposition processes are performed according to different process programs) have different deposition loading effect coefficients. More particularly, when the identical deposition processes are performed on different batches of wafers respectively with different quantities of wafers, the compensation times for the different batches of wafers are different from each other. It should be noticed that the aforementioned deposition loading effect coefficient can be obtained from querying the database 114 of the present process control system 100 according to the process program of the deposition process.

Furthermore, in the aforementioned database 114, the deposition loading effect coefficient is obtained by calculating a thickness-quantity relationship according to a plurality of history deposition thickness values obtained by performing the deposition process with respect to the same process program on the wafers in the tool, and the quantities of the wafers respectively corresponding to the history deposition thickness values.

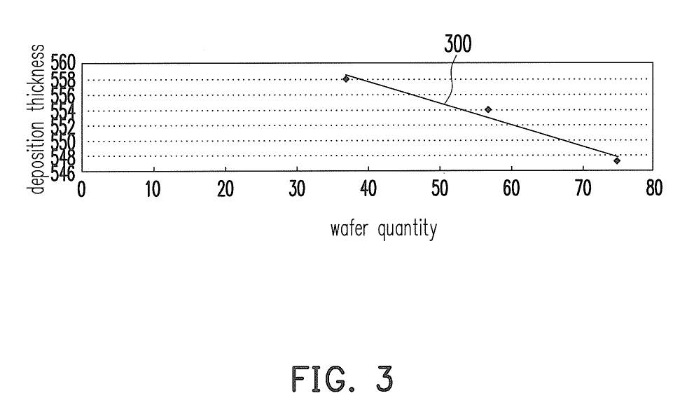

FIG. 3 is a plot diagram showing a deposition thickness-wafer quantity relationship according to one embodiment of the present invention. As shown in FIG. 3, among the batches of wafers respectively with different wafer quantities, by analyzing the deposition thicknesses of the material layers respectively on the control wafers under the same process program, it is clear that the deposition thicknesses of the material layers respectively on the control wafers in different batches of wafers respectively with different wafer quantities are different from each other due to the loading effect. More particularly, under the same process program, when the quantity of the wafers is increased, the deposition thickness of each of the material layer on the wafers is decreased. In the present embodiment, the database 114 of the process control system 100 of the present invention stores a plurality of history deposition thickness values. Furthermore, the history deposition thickness values respectively correspond to the quantities of wafers in the same deposition process run. By analyzing the history deposition thickness values and the corresponding quantities of wafers, the thickness-quantity relationship can be calculated. Also, the thickness-quantity relationship and the deposition rate of the deposition process are used to calculate a unit-wafer compensation time for the deposition process performed according to the process program as the deposition loading effect coefficient

For instance, as shown in FIG. 3, by referring to the deposition thickness-wafer quantity relationship curve 300, it is clear that, in the deposition process runs under the same process program, there is a deposition thickness difference of 6 angstroms between the material layer on each of 35 pieces of wafers and the material layer on each of 55 pieces of wafers. That is, the deposition thickness of the material layer on each of 35 pieces of wafers is 6-angstrom larger than the deposition thickness of the material layer on each of 55 pieces of wafers. When the deposition rate of the deposition process under the process program is 0.4 angstroms per second, the unit-wafer compensation time is 0.3 seconds. In other words, when the deposition process performed on the batch of 35 pieces of wafers and the deposition process performed on the bath of 55 pieces of wafers are under the same process program, additional 10.5 seconds are added to the process time of the deposition process performed on the batch of 35 pieces of wafers and additional 16.5 seconds are added to the process time of the deposition process performed on the batch of 55 pieces of wafers so as to compensate the deposition thickness loss due to the deposition loading effect. Thus, the deposition thickness of the material layer on each of 35 pieces of wafers is equal to the deposition thickness of the material layer on each of 55 pieces of wafers.

In another embodiment, the deposition loading effect coefficients stored in the aforementioned database 114 are obtained by analyzing the history deposition thickness values which are the measured deposition results of the deposition processes performed by the tool 102 at the target operation condition. That is, the deposition loading effect coefficients provided by the database 114 are the thickness-quantity relationships while the deposition processes are performed by the tool at the target operation condition. Moreover, during each process run performed on each batch of wafers 104 by the tool 102, the tool 102 is tuned at the target operation condition. Thus, before the tool 102 performs the deposition process on each batch of wafers 104, the process control system 100 calculates the deposition compensation time according to the quantity of the wafers to be loaded and according to the deposition loading effect coefficient which corresponds to the process program of the deposition process and is retrieved from the database 114. Further, the deposition compensation time is feedback to the current run of the deposition process performed by the tool at the target operation condition. Thus, the deposition results of all process runs under the same process program are more accurate.

In the step S211, the deposition time adjusting unit 110 of the process control system 100 is used to adjust the process time to be an adjusted process time according to the deposition compensation time.

In the step S215, the control unit 112 of the process control system 100 controls the tool 102 to perform the deposition process with respect to the process program on the batch of the wafers 104 for the adjusted process time.

In the present embodiment, the process control method can be implemented by executing a computer readable program. Further, the aforementioned process control system can be the aforementioned computer readable program. The computer readable program is stored in a computer readable and writable recording medium and executes a plurality of commands for implementing the process control method of the present invention. The steps of the process control method implemented by executing the commands are detailed in the previous embodiments and are not further described herein.

Accordingly, in the present invention, before each run of the deposition process, the process control system calculates a deposition compensation time for the current process run according the quantity of wafers in the current process run. Hence, the deposition process which is performed for the adjusted process time according to the deposition compensation time can overcome the problem that the deposition thickness varies with the quantities of the wafers in different process runs due to the deposition loading effect. In other words, the advanced process control (APC)_system is an open-loop APC system. Moreover, in the present invention, before the deposition process is performed, the deposition compensation time for the current process run is calculated according to the corresponding deposition loading effect coefficient provided by the database. Since the deposition loading effect coefficients stored in the aforementioned database are obtained by analyzing the history deposition thickness values which are the measured deposition results of the deposition processes performed by the tool at the target operation condition. That is, the deposition loading effect coefficients provided by the database are the thickness-quantity relationships while the deposition processes are performed by the tool at the target operation condition. Therefore, the deposition compensation time is calculated according to the quantity of the wafers to be loaded and according to the deposition loading effect coefficient which corresponds to the process program of the deposition process and is retrieved from the database. Further, the deposition compensation time is feedback to the current run of the deposition process performed by the tool at the target operation condition. Thus, the deposition results of all process runs under the same process program are more accurate. By comparing with the conventional close-loop APC, the process control method of the present invention which is an open-loop APC is risk free from that the process result of the batch of wafers of the current process run seriously drift away from the standards and it is unnecessary to waste time for waiting for the measurement result of the deposition process of the current process run to feedback the process parameters of the next process run. Hence, the process control method and the process control system of the present invention can effectively increase the accuracy of the process, decrease the process cycle time and increase the process throughput.

Although the invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A process control method for controlling a tool to process a deposition process on a plurality of wafers for a process time, the process control method comprising:
receiving a quantity of the wafers;
calculating a deposition compensation time necessary for the deposition process performed on the wafers by the tool according to the quantity of the wafers and a deposition loading effect coefficient corresponding to the deposition process, wherein the deposition loading effect coefficient is retrieved from a database according to a process program of the deposition process;
adjusting the process time to be an adjusted process time according to the deposition compensation time; and
performing the deposition process on the wafers for the adjusted process time by the tool.

2. The process control method of claim 1, wherein the tool includes a furnace.

3. The process control method of claim 1, wherein the step of calculating the deposition compensation time according to an equation:
DT=WN×LEC, wherein DT denotes the deposition compensation time, WN denotes the quantity of the wafers and LEC denotes the deposition loading effect coefficient.

4. The process control method of claim 1, wherein the deposition loading effect coefficient is obtained by calculating a thickness-wafer quantity relationship according to a plurality of history deposition thickness values obtained by performing the deposition process with respect to the same process program on the wafers in the tool, and the quantities of the wafers respectively corresponding to the history deposition thickness values.

5. The process control method of claim 4, wherein the thickness-wafer quantity relationship and a deposition rate of the deposition process are used to calculate a unit-wafer compensation time for the deposition process performed according to the process program as the deposition loading effect coefficient.

6. A process control system for controlling a tool to process a deposition process on a plurality of wafers for a process time, the process control system comprising:
a database, wherein a deposition loading effect coefficient is retrieved from the database according to a process program of the deposition process;
a receiving unit for receiving a quantity of the wafers;
a calculation unit for calculating a deposition compensation time necessary for the deposition process performed on the wafers by the tool according to the quantity of the wafers and the deposition loading effect coefficient corresponding to the deposition process;
a deposition time adjusting unit for adjusting the process time to be an adjusted process time according to the deposition compensation time; and
a control unit for controlling the tool to perform the deposition process on the wafers for the adjusted process time.

7. The process control system of claim 6, wherein the tool includes a furnace.

8. The process control system of claim 6, wherein the calculation unit calculates the deposition compensation time according to an equation:
DT=WN×LEC, wherein DT denotes the deposition compensation time, WN denotes the quantity of the wafers and LEC denotes the deposition loading effect coefficient.

9. The process control system of claim 6, wherein the deposition loading effect coefficient is obtained by calculating a thickness-wafer quantity relationship according to a plurality of history deposition thickness values obtained by performing the deposition process with respect to the same process program on the wafers in the tool, and the quantities of the wafers respectively corresponding to the history deposition thickness values.

10. The process control system of claim 9, wherein the thickness-wafer quantity relationship and a deposition rate of the deposition process are used to calculate a unit-wafer compensation time for the deposition process performed according to the process program as the deposition loading effect coefficient.
